(19) United States
(12) Patent Application Publication
(10) Pub. No.: US 2012/0178625 A1
(43) Pub. Date: Jul. 12, 2012

(54) METHOD FOR REDUCING PISTILLATE FLOWER ABORTION IN PLANTS

(75) Inventors: Jorge Pedro Nitsche, Santiago (CL); Reinaldo Munitiz, San Felipe (CL); Jerson Felipe Blanco, Portal Marino (CL); Fernando Javier Jofre, Rancagua (CL)

(73) Assignee: BASF SE, Ludwigshafen (DE)

(21) Appl. No.: 13/497,916

(22) PCT Filed: Sep. 20, 2010
(86) PCT No.: PCT/EP10/63767

§ 371 Date: Mar. 23, 2012

(30) Foreign Application Priority Data
Sep. 25, 2009 (EP) 09171407.1

(51) Int. Cl. A01N 43/56; A01P 21/00

(52) U.S. Cl. 504/139; 504/282

(57) ABSTRACT

The present invention relates to a method for reducing pistillate flower abortion in plants, comprising treating the plant, plant parts, the locus where the plant is growing or is intended to grow and/or the seeds from which the plant grows with at least one strobilurin (compound A). In addition, the invention relates to the use of at least one strobilurin for reducing pistillate flower abortion in plants.

The present invention relates to a method for reducing pistillate flower abortion in plants, comprising treating the plant, plant parts, the locus where the plant is growing or is intended to grow and/or the seeds from which the plant grows with at least one strobilurin (compound A).

In addition, the invention relates to the use of at least one strobilurin for reducing pistillate flower abortion in plants. A preferred embodiment of the invention relates to the use of at least one strobilurin for reducing pistillate flower abortion in walnuts (Juglans regia).

Pistillate flower abortion (PFA) is understood as the loss of flowers early in the season. PFA is typically induced by excessive pollen load on female flowers eventually leading to their abscission. One key factor for such excessive pollen load is the degree of overlap of female and male flowering which in turn is influenced by various parameters such as the accumulation of winter chilling and the age of the respective plants. As a consequence, fruit set, the number of growing fruits and the potential fruit yield (remaining fruits at harvest) is severely reduced. Among other plants, walnuts (Juglans regia) are especially affected. Within the genus of walnuts, Juglans regia var. Serr is of special economic importance owing to its high nut quality. It is extensively planted in Chile and in other walnut-producing areas of the world. In some seasons fruit production is low, mainly because of two factors: the abscission of pistillate flowers (PFA) owing to a high density of pollen in the orchard, and/or flower drop because of the lack of pollination leading to great economic losses of the farmer.

Research in walnut orchards under field conditions indicates losses of up to 90% by PFA (cf. Rovira and Aletá (1997): Pistillate flower abscission on four walnut cultivars. Acta Hort. (ISHS). 442: 231-234). It could also be shown that losses because of PFA are generally greater than losses because of lack of pollination (cf. Krueger (2000): Pollination of English walnut: practices and problems. Hortechnology 10: 127-130).

During the last years, it was reported that the application of aminoethoxyvinylglycine (AVG) reduces the problem of abscission owing to excess pollen (cf. Lemus et al. (2007): Control of pistillate flower abortion in “Serr” walnut in Chile by inhibiting ethylene biosynthesis with AVG. Advances in plant ethylene research: Proceedings of the 7th International Symposium on the Plant Hormone Ethylene: 305-307). Other alternatives that have been evaluated are shaking trees with the objective of eliminating part of the plant's catkins (cf. Lemus (2005): Control de la caída de flores en nogal “Serr”. Tierra Adentro 63: 18-21). Another approach which is currently tested is the use of 1-methylclyclopropene (1-MCP) for reducing PFA. However, to date no information in the prior art can be found which would indicate the use of strobilurins (compounds A) for reducing pistillate flower abortion in plants.

The strobilurins (compound A) used in the method according to the present invention are known as fungicides, as compounds having plant health activity and in some cases as insecticides (cf., for example EP-A 178 826, EP-A 278 595, EP-A 253 213, EP-A 254 426, EP-A 398 692, EP-A 477 631, EP-A 628 540, EP-A 280 185, EP-A 350 691, EP-A 460 575, EP-A 463 488, EP-A 382 375, EP-A 398 692, WO 93/15046, WO 95/18789, WO 95/24396, WO 95/21153, WO 95/21154, WO 96/01256, WO 97/05103, WO 97/15552, WO 97/06133, WO 01/82701, WO 03/075663, WO 04/043150 and WO 07/104660). Their pesticidal action and methods for producing them are generally known.

The publications cited above describe synthesis routes for the preparation of the active ingredients (compound A) used in the method according to the invention.

The further active ingredients (compound B) and methods for producing them are also generally known. For instance, the commercially available compounds may be found in The Pesticide Manual, 14th Edition, British Crop Protection Council (2006) among other publications.

The good compatibility of the strobilurins with plants at the concentrations required for reducing PFA permits the treatment of aerial plant parts and also the treatment of propagation material such as seed, but also of the soil.

In the method according to the invention, the active ingredients are taken up by the plant (for example via the leaves, the roots or flowers), finally causing overall protection of the plant. Thus, the protective action after carrying out the method according to the invention is not just found in those plant parts, which have been sprayed directly, but within the entire plant.

Besides the problem of PFA, farmers encounter various other problems which harm the health of a plant and which in turn lead to a reduction in yield. One very serious problem, is for example the occurrence of bacterial induced diseases such as the walnut blight which is based on an infection of walnuts by the pathogen Xanthomonas campestris pv. juglandis. As a consequence, walnut growers do not only need to worry about PFA but also about walnut blight. To prevent devastating crop losses and reduced nut quality, currently at least two different compounds need to be applied: a) antibiotics such as Streptomicine sulfate and/or Oxitetracicline clorhidrate for Xanthomas control and b) aminoethoxyvinylglycine (AVG) to reduce PFA. However, the use of antibiotics in plant protection is forbidden in many countries because these antibiotics rely on the same mechanisms of action as are used against bacterial pathogens in human and veterinary medicine. They may thus favor the build-up of resistances. Moreover, antibiotics are expensive, owing to their molecular structures (most of which are complicated) and can only be produced by biotechnological methods. The application of AVG on the other side has also various disadvantages such as its high costs and the lack of flexibility with respect to the application time point.

WO 03/075663 discloses that strobilurins (compound A) may be used for immunizing plants against bacterioses. When treated with a strobilurin, the plant's immune system is triggered to defend against phytopathogenic bacteria. As a consequence, bloom time applications of strobilurins (compound A) according to the invention are simultaneously part of bacteria control (such as the control of walnut blight) and PFA management giving farmers a new tool to solve both problems at once using only one compound which is a strobilurin (compound A), preferably pyraclostrobin. Some of the advantages that this could represent are, by one side, a better anti resistance management of walnut blight by adding a new mode of action and an alternative to the currently antibiotic based programs. Compared to AVG, the current method according to the invention is much more flexible in its application time point than the very specific phenological stage at which AVG application must be carried out giving in turn the farmer the possibility of higher planning independence.

It was therefore an object of the present invention to provide a method which solves the problems outlined above, and which should, in particular, reduce PFA in plants.

A reduction in PFA is desirable since it results among others in higher yields and/or a better quality of the plants, plant parts and/or their products (such as fruits and nuts).

Surprisingly, we have found that this object is achieved by treating the plants, plant parts (such as flowers) and/or plant propagules with at least one strobilurin (compound A).

Furthermore it was found that certain mixtures additionally comprising at least one further compound (compound B) also showed the PFA reducing effects according to the method of the present invention.

In one embodimemt of the method according to the invention, the applied strobilurin (compound A) is selected from the group consisting of pyraclostrobin, orysastrobin, azoxystrobin, dimoxystrobin, enestroburin, fluoxastrobin, kresoxim-methyl, metominostrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethypenzyl)carbamate and 2-(2-(3-(2,6-dichlorophenyl)-1-methyl-allylideneaminooxymethyl)-phenyl)-2-methoxyimino-N-methyl-acetamide.

In a preferred embodiment of the method according to the invention, the applied strobilurin (compound A) is selected from the group consisting of pyraclostrobin, orysastrobin, azoxystrobin, dimoxystrobin, enestroburin, fluoxastrobin, kresoxim-methyl, metominostrobin, picoxystrobin, pyribencarb and trifloxystrobin.

In a more preferred embodiment of the method according to the invention, the applied strobilurin (compound A) is pyraclostrobin.

In another more preferred embodiment according to the invention, the applied strobilurin (compound A) is azoxystrobin.

The remarks as to preferred embodiments of the compounds selected from the group consisting of strobilurins (compounds A) and respective mixtures additionally comprising at least one further compound selected from the group consisting of at least one compound (B), to their preferred use and methods of using them are to be understood either each on their own or preferably in combination with each other.

As pointed out above, the present invention relates to a method for reducing PFA in plants comprising the application of at least one strobilurin (compound A) or an agrochemical mixture additionally comprising at least one active ingredient (compound B).

In a preferred embodiment of the method according to the invention at least one further compound (compound B) is applied selected from the group consisting of
(i) carboxylic amides selected from fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1 H-pyrazole-4-carboxamide, sedaxane, isopyrazam and penthiopyrad;
(ii) azoles selected from cyproconazole, difenoconazole, epoxiconazole, flusilazole, fluquinconazole, flutriafol, ipconazole, metconazole, propiconazole, prothioconazole, tebuconazole, cyazofamid, prochloraz, ethaboxam and triazoxide;
(iii) heterocyclic compounds selected from famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;
(iv) carbamates and dithiocarbamates selected from mancozeb, metiram, iprovalicarb, maneb, propineb, flubenthiavalicarb (benthiavalicarb) and propamocarb
(v) organo-chloro compounds selected from thiophanate methyl, chlorothalonil, tolylfluanid and flusulfamid;
(vi) copper compounds selected from Bordeaux mixture, copper acetate, copper hydroxide, copper oxychloride, tribasic copper sulphate, copper (I) oxide and basic copper sulfate;
(vii) various selected from ametoctradin, spiroxamine, cymoxanil, cyflufenamid, valiphenal, metrafenone, fosetly-aluminium and dithianon.
(viii) ethylene inhibitors selected from aminoethoxyvinylglycine (AVG), 1-methylcyclopropene, derivatives of vinylglycine, hydroxylamines and oxime ether derivatives.

In a preferred embodiment according to the invention, an agrochemical mixture is applied comprising

(1) at least one strobilurin (compound A); and

(2) at least one additional compound (compound B), wherein compound (B) is selected from the group of carboxylic amides (i) consisting of fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam and penthiopyrad.

In a more preferred embodiment according to the invention, an agrochemical mixture is applied comprising

(1) pyraclostrobin (compound A); and

(2) at least one additional compound (compound B), wherein compound (B) is selected from the group of carboxylic amides (i) consisting of fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1 H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam and penthiopyrad.

In a preferred embodiment according to the invention, compound (B) is boscalid.

In another preferred embodiment according to the invention, compound (B) is N-(3′,4′,5′-trifluorobiphenyl-2-yl)-3-difluoromethyl-1-methyl-1H-pyrazole-4-carboxamide (fluxapyroxad).

In another preferred embodiment according to the invention, an agrochemical mixture is applied comprising

(1) at least one strobilurin (compound A); and

(2) at least one additional compound (compound B), wherein compound (B) is selected from the group of copper compounds (vi) selected from the group consisting of Bordeaux mixture, copper acetate, copper hydroxide, copper oxychloride, tribasic copper sulphate, copper (I) oxide and basic copper sulfate.

In a more preferred embodiment according to the invention, an agrochemical mixture is applied comprising

(1) pyraclostrobin (compound A); and

(2) at least one additional compound (compound B), wherein compound (B) is selected from the group of copper compounds (vi) selected from the group consisting of Bordeaux mixture, copper acetate, copper hydroxide, copper oxychloride, tribasic copper sulphate, copper (I) oxide and basic copper sulfate.

In an especially preferred embodiment according to the invention, compound (B) is copper oxychlorid.

In one embodiment of the method according to the invention, at least one strobilurin (compound A) is applied in rotation with at least one copper compound (vi).

In another preferred embodiment according to the invention, an agrochemical mixture is applied comprising

(1) at least one strobilurin (compound A); and

(2) at least one additional compound (compound B), wherein compound (B) is selected from the group consisting of the group of ethylene inhibitors (vii) selected from aminoethoxyvinylglycine (AVG), 1-methylcyclopropene, derivatives of vinylglycine, hydroxylamines and oxime ether derivatives.

In a more preferred embodiment according to the invention, an agrochemical mixture is applied comprising

(1) pyraclostrobin (compound A); and

(2) at least one additional compound (compound B), wherein compound (B) is selected from the group consisting of the group of ethylene inhibitors (vii) selected from aminoethoxyvinylglycine (AVG), 1-methylcyclopropene, derivatives of vinylglycine, hydroxylamines and oxime ether derivatives.

In a preferred embodiment of the method according to the invention, compound (B) is aminoethoxyvinylglycine (AVG).

In a more preferred embodiment of the method according to the invention, an agrochemical mixture is applied comprising pyraclostrobin as compound (A) and boscalid or aminoethoxyvinylglycine (AVG) as compound (B).

In another preferred embodiment according to the invention, compound (B) is 1-methylcyclopropene (1-MCP).

In the terms of the present invention “mixture” is not restricted to a physical mixture comprising compound (A) and at least one compound (B) but refers to any preparation form of compound (A) and at least one compound (B), the use of which is time- and locus-related. In one embodiment of the invention “mixture” refers to a physical mixture of one compound (A) and one compound (B).

In another embodiment of the invention, “mixture” refers to at least one compound (A) and at least one compound (B) formulated separately but applied to the same plant in a temporal relationship, i.e. simultaneously or subsequently, the subsequent application having a time interval which allows a combined action of the compounds.

Furthermore, the individual compounds of the mixtures according to the invention such as parts of a kit or parts of the binary mixture may be mixed by the user himself in a spray tank and further auxiliaries may be added, if appropriate (tank mix). This applies also in case ternary mixtures are used according to the invention.

In one embodiment of the method according to the invention, compound (A) and compound (B) as defined above are applied as an synergistic agrochemical mixture in synergistically the level of PFA reducing amounts.

Preferably, all above-mentioned mixtures comprise at least one strobilurin selected from the group consisting of pyraclostrobin, azoxystrobin, kresoxim-methyl, trifloxystrobin and picoxystrobin as compound (A). More preferably, these mixtures comprise pyraclostrobin, azoxystrobin, trifloxystrobin as compound (A). Most preferably, these mixtures comprise pyraclostrobin as compound (A).

In an especially preferred embodiment of the invention, an agrochemical mixture is applied comprising pyraclostrobin and boscalid.

All mixtures set forth above are also an embodiment of the present invention.

The plants to be treated are generally plants of economic importance and/or men-grown plants. They are preferably selected from the group consisting of agricultural, silvicultural, ornamental and horticultural plants, each in its natural or genetically modified form.

In a preferred embodiment of the invention, the plant to be treated according to the invention has an incomplete flower. Accordingly, in a preferred embodiment of the method according to the invention, the plant is selected from the group consisting of plants which belong to the family of the Fagaceae (oak family), Betulaceae (birch family) or Juglandaceae (walnut family).

In a preferred embodiment of the invention, the plant to be treated according to the invention is a silvicultural plant.

In a preferred embodiment of the invention, the plant to be treated according to the method of the invention is a perennial plant.

In a preferred embodiment of the method according to the invention, the plant belongs to the genus Juglans. The genus Juglans belongs to the family of Juglandaceae.

In an even more preferred embodiment of the invention, the plant to be treated according to the invention belongs to the Section Juglans selected from the group consisting of Juglans regia (also known as Common walnut, Persian walnut, or English walnut) and Juglans sigillata (also known as Iron Walnut).

In an especially preferred embodiment of the invention, the plant to be treated is Juglans regia; of utmost preference is the variety Juglans regia cv. Serr.

In a most preferred embodiment of the method according to the invention, Juglans regia is treated with pyraclostrobin.

In another preferred embodiment of the invention, the plant to be treated according to the invention belongs to the Section Rhysocaryon of the genus Juglans selected from the group consisting of Juglans australis (Argentine Walnut), Juglans boliviana (Bolivian walnut, Peruvian walnut), Juglans brasiliensis (Brazilian Walnut), Juglans californica (California Black Walnut), Juglans hindsii (Hinds' Black Walnut), Juglans hirsuta (Nuevo Leon Walnut), Juglans jamaicensis West Indies Walnut), Juglans major (Arizona Black Walnut), Juglans major var. glabrata, Juglans microcarpa Berlandier (Texas Walnut or Little Black Walnut), Juglans microcarpa var. microcarpa, Juglans microcarpa var. stewartii, Juglans mollis (Mexican Walnut), Juglans neotropica (Andean Walnut), Juglans nigra (Eastern Black Walnut), Juglans olanchana (Cedro Negro, Nogal Walnut), Juglans peruviana (Peruvian Walnut), Juglans soratensis, Juglans steyermarkii (Guatemalan Walnut), Juglans venezuelensis (Venezuela Walnut).

In another preferred embodiment of the invention, the plant to be treated according to the invention belongs to the Section Cardiocaryon of the genus Juglans selected from the group consisting of Juglans ailantifolia (Japanese Walnut) and Juglans ailantifolia var. cordiformis (Heartnut).

In another preferred embodiment of the invention, the plant to be treated according to the invention belongs to the Section Trachycaryon of the genus Juglans such as Juglans cinerea (Butternut).

In yet another preferred embodiment of the invention, the plant to be treated according to the invention is a hybrid walnut of the genus Juglans selected from the group consisting of Juglans×bixbyi (J. ailantifolia×J. cinerea), Juglans×intermedia (J. nigra×J. regia), Juglans×notha (J. ailantifolia×J. regia), Juglans×quadrangulata (J. cinerea×J. regia), Juglans×sinensis (J. mandschurica×J. regia), Juglans×paradox (J. hindsii×J. regia) and Juglans×royal (J. hindsii×J. nigra).

In another preferred embodiment of the method according to the invention, the plant is selected from the group consisting of oaks (Quercus spec.). Oaks of the genus Quercus are plants that belong to the family of Fagaceae. In preferred embodiment of the invention, the plant to be treated according to the invention is selected from the group consisting of Quercus rubra, Quercus velutina and Quercus alba.

“Pistillate flower abortion” (PFA) is to be understood as the loss of flowers early in the season. PFA is typically induced by excessive pollen load on female flowers eventually leading to their abscission.

A “flower” is a branch system terminated by a series of modified leaves that are specialized for reproduction.

“Pistillate flowers” are flowers that have a pistil or pistils, but no functional stamens. A flower having sepals, petals, stamens, and pistils is called “complete”; lacking one or more of such structures, it is said to be an “incomplete flower”. Incomplete flowers can be found in all of the Fagaceae (oak family), Betulaceae (birch family) and Juglandaceae (walnut family).

The term “plant” is to be understood as any plant of economic importance and/or men-grown plants. They are preferably selected from agricultural, silvicultural, ornamental and horticultural plants. The term plant as used herein includes all parts of a plant such as flowers, germinating seeds, emerging seedlings, herbaceous vegetation as well as established woody plants including all belowground portions (such as the roots) and aboveground portions.

The term “perennial plant” is to be understood as plants that live for more than one year or a plant that lasts for more than two growing seasons either dying back after each season or growing continuously. With respect to their structure and growth habit, they are characterized by specific growth structures like storage tissues which allow them to survive periods of dormancy for example under detrimental growth conditions such as winter or extended drought. While perennial plants tend to grow continuously in warmer and more favorable climates, their growth is limited to defined growing seasons in seasonal climates. In temperate regions for example, a perennial plant may grow and bloom during the warm part of the year while during winter the growth is strongly limited or absent. Perennial plants dominate many natural ecosystems because they display a high competiveness compared to annual plants. This is especially true under poor growing conditions.

The term “agricultural plants” is to be understood as plants of which a part (e.g. seeds, fruits) or all is harvested or cultivated on a commercial scale or which serve as an important source of feed, food, fibres (e.g. cotton, linen), chemical processes (oil, sugar), combustibles (e.g. wood, bio ethanol, biodiesel, biomass) or other chemical compounds. Preferred agricultural plants are for example cereals, e.g. wheat, rye, barley, triticale, oats, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fibre plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola (oils seed rape), sugar cane or oil palm, corn, tobacco, nuts, coffee, tea, bananas, vines (table grapes and grape juice grape vines), hop, turf or natural rubber plants.

The term “horticultural plants” or “ornamental plants” is to be understood as plants which are commonly used in horticulture or for ornamental reasons and which are typically grown in gardens (and not on fields)—e.g. the cultivation of ornamentals, vegetables and/or fruits. Examples for ornamentals are turf, geranium, pelargonia, petunia, begonia, and fuchsia, to name just a few among the vast number of ornamentals. Examples for vegetables potatoes, tomatoes, peppers, cucurbits, cucumbers, melons, watermelons, garlic, onions, carrots, cabbage, beans, peas and lettuce and more preferably from tomatoes, onions, peas and lettuce, to name just a few among the vast number of vegetables. Examples for fruits are apples, pears, cherries, strawberry, citrus, peaches, apricots, blueberries, to name just a few among the vast number of fruits.

The term “silvicultural plants” is to be understood as trees, more specifically trees used in forestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm, oak and Juglans spec.

Generally the term “plants” also includes plants which have been modified by breeding, mutagenesis or genetic engineering.

The term “genetically modified plants” is to be understood as plants, which genetic material has been modified by the use of recombinant DNA techniques in a way that under natural circumstances it cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e.g. by glycosylation or polymer additions such as prenylated, acetylated or farnesylated moieties or PEG moieties. Plants that have been modified by breeding, mutagenesis or genetic engineering, e.g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as 5-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP A 374 753, WO 93/007278, WO 95/34656, EPA 427 529, EPA 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nema [symbol] toda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the CryIAc toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the CryIAc toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP A 392 225), plant disease resistance genes (e.g. potato cultivars, which express resistance genes acting against Phytophthora infestans derived from the Mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. biomass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

In the terms of the present invention a “mixture” means a combination of at least two active ingredients (e.g. one compound (A) and one compound (B)).

The term “at least one compound” is to be understood as 1, 2, 3 or more compounds (e.g. strobilurins).

The term “synergistically” means that the purely additive (in mathematical terms) effects of a simultaneous, that is joint or separate application of at least one compound (A) and at least one compound (B) or their successive application is surpassed by the application of a mixture according to the invention. The term “synergistic effect” is understood to refer in particular to that defined by Colby's formula (Colby, S. R., “Calculating synergistic and antagonistic responses of herbicide combinations”, Weeds, 15, pp. 20-22, 1967).

The term “synergistically PFA reducing amounts” means that the mixture according to the invention may be applied in amounts which decrease the level of PFA in a manner which surpasses the purely additive (in mathematical terms) effect of a simultaneous, that is joint or separate application of at least one compound (A) and at least one compound (B) or a successive application of at least one compound (A) and at least one compound (B).

In the terms of the present invention, “agriculturally useful salts” are especially those cations and anions which do not have any adverse effect on the action of the compounds according to the invention such as a) suitable cations, which are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH4+) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium as well as b) suitable anions of useful acid addition salts, which are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formiate, acetate, propionate and butyrate.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

In one embodiment of the invention, the respective application is carried out before the reproductive growth phase.

In a preferred embodiment of the invention, the respective application is carried out during the reproductive growth phase.

In a preferred embodiment of the invention, the strobilurin (compound A) or the agrochemical mixture is applied at any BBCH principal growth stage (GS) ranging from GS 60 (first flowers open) to GS 69 (end of flowering).

In a more preferred embodiment of the invention, the strobilurin (compound A) or the agrochemical mixture is applied three times wherein the first application is carried out at the BBCH principal growth stage GS 60, the second application is carried out at the BBCH principal growth stage GS 62 and the third application is carried out at the BBCH principal growth stage GS 65.

In a preferred embodiment of the invention, at least one strobilurin (compound A) or an agrochemical mixture is applied to the foliage and/or the flowers of a plant.

In a preferred embodiment of the invention, at least one strobilurin or an agrochemical mixture is applied during the flowering period of a plant.

In a preferred embodiment of the invention, at least one strobilurin (compound A) or the agrochemical mixture is applied as foliar application. In an even more preferred embodiment of the invention, at least one strobilurin (compound A) or the agrochemical mixture is applied to the flowers of a plant.

If a mixture according to the present invention is used in this inventive method, the plants are treated simultaneously (together or separately) or subsequently with at least one strobilurin (compound A) and at least one further compound (compound B).

In a preferred embodiment of the method according to the invention, the plants are treated simultaneously (together or separately) with at least one strobilurin (compound A) and at least one further compound (compound B).

A subsequent application is carried out with a time interval which allows a combined action of the applied compounds. Preferably, the time interval for a subsequent application of at least one compound (A) and at least one compound (B) ranges from a few seconds up to 3 months, preferably, from a few seconds up to 1 month, more preferably from a few seconds up to 2 weeks, even more preferably from a few seconds up to 3 days and in particular from 1 second up to 24 hours.

Herein, we have found that simultaneous, that is joint or separate application of synergistic mixtures comprising at least one compound (A) and at least one compound (B) or the successive application of at least one compound (A) and at least one compound (B) allows reducing pistillate flower abortion in plants to a level that surpasses the reduction of pistillate flower abortion that is achieved by the application of the individual compounds alone.

In the terms of the present invention, “reducing pistillate flower abortion in plants” refers to a reduction in the level of PFA. This reduction can be measured by determining a) the fruit set (%), b) the number of growing fruits (%) and/or c) the remaining fruits at harvest (%) (fruit yield). The higher the percentage of fruit set, growing fruits and/or remaining fruits at harvest, the lower the respective pistillate flower abortion.

According to one embodiment of the invention, the level of fruit set and/or number of growing fruits and/or remaining fruits at harvest is increased by at least 20 to 40%, preferably 41 to 80% more preferably 81 to 160%, most preferable 161 to 200% or even more relative to that observed in the respective untreated control plant.

In one embodiment of the method according to the invention, the level of fruit set is increased by at least 20 to 40% relative to that observed in the respective untreated control plant.

In another embodiment of the method according to the invention, the number of growing fruits is increased by at least 20 to 40% relative to that observed in the respective untreated control plant.

In another embodiment of the method according to the invention, the number of remaining fruits is increased by at least 20 to 40% relative to that observed in the respective untreated control plant.

In a preferred embodiment of the invention, at least one strobilurin (compound A) or an agrochemical mixture as described above is repeatedly applied. In a more preferred embodiment, the application is repeated two to ten times, preferably, two to five times; most preferably three times.

In a preferred embodiment of the invention, the application is repeated three times, a single application being carried out every 3 to 5 days.

In a more preferred embodiment of the invention, the strobilurin (compound A) or the agrochemical mixture is applied three times every 4 days.

For the use according to the method of the invention, the application rates are between 0.01 kg and 2.0 kg of active ingredient per hectare, depending on the plant species. In a preferred embodiment of the method according to the invention, the application rates are between 125 g and 750 g of active ingredient per hectare. In an even more preferred embodiment of the method according to the invention, the application rates are between 200 g and 300 g of active ingredient per hectare.

In the treatment of seed, amounts of from 0.001 g to 0.1 g, preferably 0.01 g to 0.05 g, of active ingredient are generally required per kilogram of seed.

As a matter of course, compound (A) and in case mixtures are employed, at least one compound (A) and at least one compound (B) are used in effective and non-phytotoxic amounts. This means that they are used in a quantity which allows to obtain the desired effect but which does not give rise to any phytotoxic symptom on the treated plant.

In the methods according to the invention, the application rates of the mixtures according to the invention are from 0,3 g/ha to 2500 g/ha, preferably 5 g/ha to 2500 g/ha, more preferably from 20 to 2000 g/ha, in particular from 20 to 1500 g/ha, depending on the type of compound.

The compounds according to the invention can be present in different crystal modifications whose biological activity may differ. They are likewise subject matter of the present invention.

In the treatment of plant propagules, preferably seed, application rates of mixture of the present invention are generally from 0.001 to 1000 g per 250 kg of plant propagules, preferably seed, preferably from 0.01 to 500 g per 100 kg, in particular from 0.1 g to 250 g per 100 kg of plant propagules, preferably seed.

The weight ratio of compound (A) to a compound (B) is preferably from 200:1 to 1:200, more preferably from 100:1 to 1:100, more preferably from 50:1 to 1:50 and in particular from 20:1 to 1:20. The utmost preferred ratio is 1:10 to 10:1. The weight ratio refers to the total weight of compound (A) and compound (B) in the mixture.

The strobilurins (compound A) as well as the agrochemical mixtures are typically applied as compositions comprising at least one strobilurin (compound A) or an agrochemical mixture additionally comprising a further compound (B).

Examples for composition types are suspensions (SC, OD, FS), emulsifiable concentrates (EC), emulsions (EW, EO, ES), microemulsions (ME), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone. Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany),and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e. g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan). Powders, materials for spreading and dusts can be prepared by mixing or concomitantly grinding the compounds I and, if appropriate, further active substances, with at least one solid carrier. Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g. ammonium sulfate, ammonium phosphate, ammonium nitrate, ureas, and products of vegetable origin, such as cereal meal, tree bark meal, wood meal and nutshell meal, cellulose powders and other solid carriers.

Examples for composition types are:

1. Composition Types for Dilution with Water

i) Water-Soluble Concentrates (SL, LS)

10 parts by weight of a compound I according to the invention are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

ii) Dispersible Concentrates (DC)

20 parts by weight of a compound I according to the invention are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable Concentrates (EC)

15 parts by weight of a compound I according to the invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

iv) Emulsions (EW, EO, ES)

25 parts by weight of a compound I according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

v) Suspensions (SC, OD, FS)

In an agitated ball mill, 20 parts by weight of a compound I according to the invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-Dispersible Granules and Water-Soluble Granules (WG, SG)

50 parts by weight of a compound I according to the invention are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-Dispersible Powders and Water-Soluble Powders (WP, SP, SS, WS)

75 parts by weight of a compound I according to the invention are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of a compound I according to the invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable Powders (DP, DS)

5 parts by weight of a compound I according to the invention are ground finely and mixed intimately with 95 parts by weight of finely divided kaolin. This gives a dustable composition having an active substance content of 5% by weight.

x) Granules (GR, FG, GG, MG)

0.5 parts by weight of a compound I according to the invention is ground finely and associated with 99.5 parts by weight of carriers. Current methods are extrusion, spray-drying or the fluidized bed. This gives granules to be applied undiluted having an active substance content of 0.5% by weight.

xi) ULV Solutions (UL)

10 parts by weight of a compound I according to the invention are dissolved in 90 parts by weight of an organic solvent, e.g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting, soaking and in-furrow application methods of the propagation material. In a preferred embodiment, the compounds or the compositions thereof, respectively, are applied on to the plant propagation material by a method such that germination is not induced, e. g. by seed dressing, pelleting, coating and dusting.

In a preferred embodiment, a suspension-type (FS) composition is used for seed treatment. Typically, a FS composition may comprise 1-800 g/l of active substance, 1 200 g/l surfactant, 0 to 200 g/l antifreezing agent, 0 to 400 g/l of binder, 0 to 200 g/l of a pigment and up to 1 liter of a solvent, preferably water.

The active substances can be used as such or in the form of their compositions, e. g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®.

The compositions according to the invention can also be present together with other active substances, e.g. with herbicides, insecticides, growth regulators, fungicides or else with fertilizers, as pre-mix or, if appropriate, not until immediately prior to use (tank mix).

The following examples are intended to illustrate the invention, but without imposing any limitation.

### EXAMPLES

### Example 1

The trial was run in a walnut orchard (Juglans regia cv. Serr) located in Graneros, Chile in the year 2008. Trial design was completely randomized with 3 replicates per treatment. Each replicate had identified branches completing 100 female flowers. Remaining fruit were counted after fruit set and at harvest time. Table 1 shows the treatments and application timing.

TABLE 1
Control of PFA in Graneros, Chile (2008): Experimental setup

| | | | Application time point | | | |
|---|---|---|---|---|---|---|
| | | | 10% of | 30% of | 50% of | Water |
| | Treatment | No. | pistillates | pistillates | pistillates | volume |
| No. | (T) | of T | flowering | flowering | flowering | (l/ha) |
| 1 | Untreated | 0 | — | — | — | — |
| | Control | | | | | |
| | (UTC) | | | | | |
| 2 | Pyra- | 2 | 0.5 l/ha | 0.5 l/ha | — | 1500 |
| | clostrobin | | | | | |
| 3 | Pyra- | 2 | 0.7 l/ha + | 0.7 l/ha + | — | 1500 |
| | clostrobin + | | 0.015% | 0.015% | | |
| | Break- | | | | | |
| | Thru ® | | | | | |
| 4 | Pyra- | 2 | 1.25 l/ha + | 1.25 l/ha + | — | 1500 |
| | clostrobin + | | 0.015% | 0.015% | | |
| | Break- | | | | | |
| | Thru ® | | | | | |
| 5 | Pyra- | 3 | 0.7 l/ha + | 0.7 l/ha + | 0.7 l/ha + | 1500 |
| | clostrobin + | | 0.015% | 0.015% | 0.015% | |
| | Break- | | | | | |
| | Thru ® | | | | | |

(Break-Thru ® = a organosilicone surfactant)

Under the 2008 season conditions, male and female blooming period for walnuts in the central region of Chile had a big coincidence in time. As a consequence PFA was quite high, influencing adversely yields in orchard where no ethylene control was done.

Table 2 shows the fruit set percentage assessed in the different treatments and the remaining fruit until harvest time.

TABLE 2
Control of PFA in Graneros, Chile (2008/2009): Results

| | | Increase (%) | Small growing | Increase (%) | Remaining fruits | Increase (%) |
|---|---|---|---|---|---|---|
| | Fruit set (%) | compared | fruits (%) | compared | at harvest (%) | compared |
| No. | (Oct. 23, 2008) | to UTC | (Nov. 10, 2008) | to UTC | (Mar. 03, 2009) | to UTC |
| 1 | 26.0 | — | 22.7 | — | 22.3 | — |
| 2 | 54.0 | +108 | 46.3 | +104 | 46.0 | +106 |
| 3 | 45.0 | +73 | 45.0 | +98 | 41.3 | +85 |
| 4 | 59.7 | +127 | 57.7 | +154 | 53.3 | +139 |
| 5 | 69.0 | +165 | 68.3 | +201 | 67.0 | +200 |

As can be seen in table 2 (cf. experiment No. 5), pyraclostrobin applied during the bloom period of walnuts (Juglans regia cv. Serr) significantly increased the fruit set (+165%), the number of small growing fruits (+201%) and the number of remaining fruits at harvest (+200%) when applied three times. As a consequence, the fruit drop was severely reduced until harvest resulting in considerable yield increase. Based on the data provided, it can be seen that the method according to the invention significantly reduces PFA in plants.

1-15. (canceled)

16. A method for reducing pistillate flower abortion in plants, comprising treating the plant, plant parts, the locus where the plant is growing or is intended to grow and/or the seeds from which the plant grows with at least one strobilurin compound (A).

17. The method according to claim 16, wherein the applied strobilurin compound (A) is selected from the group consisting of pyraclostrobin, orysastrobin, azoxystrobin, dimoxystrobin, enestroburin, fluoxastrobin, kresoxim-methyl, metominostrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate and 2-(2-(3-(2,6-dichlorophenyl)-1-methyl-allylideneaminooxymethyl)-phenyl)-2-methoxyimino-N-methyl-acetamide.

18. The method according to claim 16, wherein the applied strobilurin compound (A) is selected from the group consisting of pyraclostrobin, orysastrobin, azoxystrobin, dimoxystrobin, enestroburin, fluoxastrobin, kresoxim-methyl, metominostrobin, picoxystrobin, pyribencarb and trifloxystrobin.

19. The method according to claim 16, wherein the applied strobilurin compound (A) is pyraclostrobin.

20. The method according to claim 16, wherein at least one further compound (B) is applied, wherein compound (B) is selected from the group consisting of
(i) a carboxylic amide selected from the group consisting of fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam and penthiopyrad;
(ii) an azole selected from the group consisting of cyproconazole, difenoconazole, epoxiconazole, flusilazole, fluquinconazole, flutriafol, ipconazole, metconazole, propiconazole, prothioconazole, tebuconazole, cyazofam id, prochloraz, ethaboxam and triazoxide;
(iii) a heterocyclic compound selected from the group consisting of famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;
(iv) a carbamate or dithiocarbamate selected from the group consisting of mancozeb, metiram, iprovalicarb, maneb, propineb, flubenthiavalicarb (benthiavalicarb) and propamocarb
(v) an organo-chloro compound selected from the group consisting of thiophanate methyl, chlorothalonil, tolylfluanid and flusulfamid;
(vi) a copper compound selected from the group consisting of Bordeaux mixture, copper acetate, copper hydroxide, copper oxychloride, tribasic copper sulphate, copper (I) oxide and basic copper sulfate;
(vii) another compound selected from the group consisting of ametoctradin, spiroxamine, cymoxanil, cyflufenamid, valiphenal, metrafenone, fosetly-aluminium and dithianon; and
(viii) an ethylene inhibitor selected from the group consisting of aminoethoxyvinylglycine (AVG), 1-methylcyclopropene, derivatives of vinylglycine, hydroxylamines and oxime ether derivatives.

21. The method according to claim 16, wherein the at least one strobilurin is applied as a mixture comprising pyraclostrobin as compound (A) and boscalid or aminoethoxyvinylglycine (AVG) as compound (B).

22. The method according to claim 16, wherein the treatment is carried out during the flowering period of a plant.

23. The method according to claim 16, wherein at least one strobilurin or an , agrochemical mixture thereof is applied to the foliage and/or the flowers of a plant.

24. The method according to claim 16, wherein at least one strobilurin or an agrochemical mixture thereof is repeatedly applied.

25. The method according to claim 24, wherein the application is repeated three times, and wherein each single application is carried out every 3 to 5 days.

26. The method according to claim 16, wherein the plant is a perennial plant.

27. The method according to claim 16, wherein the plant has an incomplete flower.

28. The method according to claim 16, wherein the plant belongs to the genus Juglans.

29. The method according to claim 28, wherein the plant is Juglans regia.
